(19) United States
(12) Patent Application Publication
(10) Pub. No.: US 2015/0145191 A1
(43) Pub. Date: May 28, 2015

(54) ISOLATORS HAVING NESTED FLEXURE DEVICES AND METHODS FOR THE PRODUCTION THEREOF

(71) Applicant: HONEYWELL INTERNATIONAL INC., Morristown, NJ (US)

(72) Inventors: Ben Smith, Glendale, AZ (US); Paul Buchele, Glendale, AZ (US); Kevin Witwer, Glendale, AZ (US)

(21) Appl. No.: 14/090,749

(22) Filed: Nov. 26, 2013

(51) Int. Cl. F16F 3/087

(52) U.S. Cl. CPC F16F 3/0873; F16F 2226/04
USPC 267/141; 29/896.93

(57) ABSTRACT

Embodiments of an isolator having a nested flexure device are provided, as are embodiments of a nested flexure device and methods for the production thereof. In one embodiment isolator includes an isolator body and a nested flexure device mounted to an end portion of the isolator body. The nested flexure device includes an inner flexure array compliant along first and second perpendicular axes orthogonal to the working axis of the isolator. The nested flexure device further includes an outer flexure array compliant along the first and second perpendicular axes, coupled in series with the inner flexure array, and circumscribing at least a portion of the inner flexure array.

### STATEMENT REGARDING FEDERALLY-SPONSORED RESEARCH OR DEVELOPMENT

This invention was made with Government support under Government Contract #FA6721-05-C-0002 awarded by MIT_Lincoln Labs. The Government has certain rights in the invention.

### TECHNICAL FIELD

The present invention relates generally to flexures and, more particularly, to embodiments of a nested flexure device well-suited for usage within axially-damping isolators, as well as to methods for producing nested flexure devices.

### BACKGROUND

Single degree-of-freedom (“DOF”), axial isolators are commonly produced to include flexure devices to accommodate angular or rotational misalignments between the mount points of the isolator. Ideally, such flexure devices are characterized by relatively low radial stiffnesses to provide the desired angular compliance, as well as a relatively high axial stiffness to avoid detracting from isolator performance. In contrast to ball joints, flexure devices eliminate play between joints and are consequently well-suited for incorporation into isolators utilized to attenuate low amplitude vibrations, such as jitter. Conventional flexure devices are, however, limited in certain respects. For example, the angular range of motion (“ROM”) of a flexure device is typically limited by flexure length. As the length of the flexure device decreases, stress concentrations within compliant portions of the flexure device (e.g., the rectangular beams of a blade-type flexure device) increase. In applications wherein the flexure device is required to be highly compact in an axial direction, the angular ROM of the flexure device may be undesirably restricted by high stress concentrations and material strength limitations. While it may be possible to increase the angular ROM by fabricating the flexure device from an exotic alloy having an exceptionally high material strength, such alloys tend to be costly and may still only permit a relatively modest increase in the angular ROM of the flexure device.

It is thus desirable to provide embodiments of a flexure device that is relatively compact in an axial direction and that provides a relatively broad angular ROM, while minimizing stress concentrations within the compliant portions of the flexure device. Ideally, embodiments of such an axially-compact flexure device would be well-suited for usage in a single DOF, axially-damping isolator, but could also be utilized in various other applications wherein it is desired to provide angular compliancy between mount points, while transmitting axial forces therebetween. Finally, it would further be desirable to provide embodiments of single DOF isolator including such an axially-compact flexure device, as well as embodiments of a method for producing such a flexure device. Other desirable features and characteristics of embodiments of the present invention will become apparent from the subsequent Detailed Description and the appended Claims, taken in conjunction with the accompanying drawings and the foregoing Background.

### BRIEF SUMMARY

Embodiments of an isolator having a nested flexure device are provided. In one embodiment, the isolator includes an isolator body and a nested flexure device mounted to an end portion of the isolator body. The nested flexure device includes inner and outer flexure arrays, which are each compliant along first and second perpendicular axes orthogonal to the working axis of the isolator. The outer flexure array is coupled in series with the inner flexure array and circumscribes at least a portion thereof.

Embodiments of a nested flexure device having a longitudinal axis are further provided. In one embodiment, the nested flexure device includes an inner flexure array compliant along first and second perpendicular axes orthogonal to the longitudinal axis. The nested flexure device further includes an outer flexure array compliant along the first and second perpendicular axes, coupled in series with the inner flexure array, and circumscribing at least a portion of the inner flexure array.

Embodiments of a method for producing a nested flexure device are still further provided. In one embodiment, the method includes providing a resilient structure having a longitudinal axis, an inner annular sidewall extending around the longitudinal axis, and an outer annular sidewall circumscribing at least a portion of the inner annular sidewall. An inner flexure array is formed in the inner annular sidewall and is compliant along first and second perpendicular axes orthogonal to the longitudinal axis. An outer flexure array is formed in the outer annular sidewall, compliant along the first and second perpendicular axes, and coupled in series with the inner flexure array.

### BRIEF DESCRIPTION OF THE DRAWINGS

At least one example of the present invention will hereinafter be described in conjunction with the following figures, wherein like numerals denote like elements, and:

FIG. 1 is a cross-sectional view of a single DOF, axial isolator including a nested flexure device, as illustrated in accordance with an exemplary embodiment of the present invention;

FIGS. 2, 3, 4, and 5 are isometric, top-down, first side, and second side views, respectively, of the exemplary nested flexure device shown in FIG. 1;

FIGS. 6-9 are cross-sectional views of the exemplary nested flexure device shown in FIGS. 1-5 and taken along various cut planes to more clearly illustrate the internal structure of the flexure device; and

FIGS. 10 and 11 are isometric and cross-sectional views, respectively, illustrating the nested flexure device shown in FIGS. 1-9 at various stages of manufacture, as produced in accordance with an exemplary embodiment of a method for manufacturing a nested flexure device.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

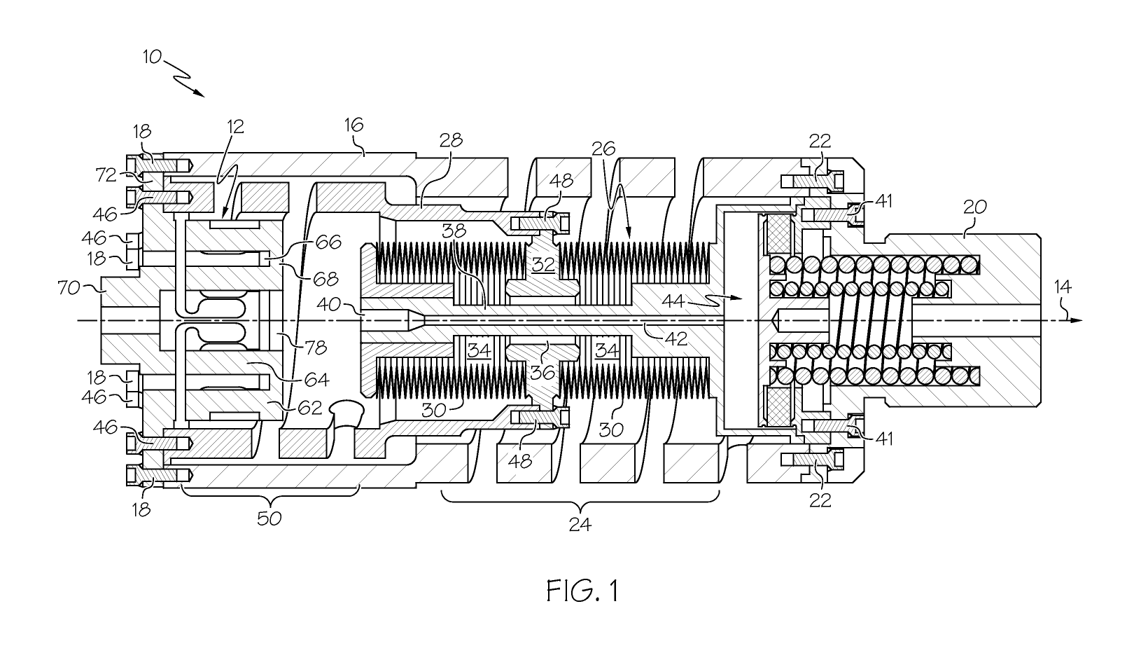

FIG. 1 is a cross-sectional view of an isolator 10 including a nested flexure device 12, as illustrated in accordance with an exemplary embodiment of the present invention. In this case, isolator 10 is a three parameter device that behaves, at least in part, as a primary spring coupled in parallel with a series-coupled secondary spring and damper. Isolator 10 may also be described as a single DOF, axially-damping device having a working axis 14, which may be co-axial with the longitudinal axis of flexure device 12. Isolator 10 is well-suited for usage in a multi-point mounting arrangement; e.g., isolator 10 can be combined with a number of like isolators in, for example, a hexapod or octopod-type mounting arrangement to provide high fidelity damping in six degrees of freedom. Such multi-point mounting arrangements are usefully employed in spacecraft isolation systems utilized to attenuate vibrations or impact forces transmitted between a spacecraft and a payload carried by the spacecraft. The instant example notwithstanding, it is emphasized that embodiments of nested flexure device 12 can be integrated into various other types of isolators, such as other three parameter isolators and two parameter isolators (e.g., tuned-mass dampers), utilized within terrestrial, waterborne, airborne, and space-borne applications. More generally, flexure device 12 need not be incorporated into an isolator in all embodiments and may instead be utilized within various other applications or platforms wherein it is desired to transmit axial forces between mount points, while providing a relatively high degree of rotational compliancy therebetween.

Three parameter isolator 10 includes an elongated, tubular isolator body 16. Nested flexure device 12 is mounted to a first end of isolator body 16 utilizing, for example, a plurality of bolts 18. An axially-projecting end piece 20 is attached to the opposing end of isolator body 16 utilizing an additional set of bolts 22. Nested flexure device 12 and axially-projecting end piece 20 thus serve as opposing mechanical inputs/outputs of isolator 10. When isolator 10 is installed within a given application, nested flexure device 12 and end piece 20 may be attached to first and second mount points, respectively, utilizing hardware (e.g., utilizing bolts, clamps, brackets, etc.), by bonding (e.g., by welding or soldering), and/or utilizing other attachment means. When isolator 10 is employed within a spacecraft isolation system, specifically, either nested flexure device 12 or end piece 20 may be affixed to the spacecraft body, while the other of flexure device 12 and end piece 20 is affixed to a payload support structure, such as an optical bench. An outer machined spring 24 is formed in an intermediate portion of isolator body 16; e.g., machined spring 24 may be cut into body 16 utilizing a laser cutting or an Electrical Discharge Machining (“EDM”) wire process. As will be described below, outer machined spring 24 may serve as the main spring of three parameter isolator 10; however, in further embodiments, a discrete coil spring may be integrated into isolator 10 and utilized for this purpose.

A damper assembly 26 is housed within tubular isolator body 16. Damper assembly 26 includes opposing bellows 30 and a disc-shaped damper piston 32, which is resiliently suspended between bellows 30. Opposing hydraulic chambers 34 are defined, in part, by bellows 30 and piston 32. Chambers 34 are fluidly coupled by an annulus 36 further defined by damper piston 32 and an elongated rod 38, which extends through a central opening provided in piston 32 and through bellows 30. Chambers 34 are fluid-tight and configured to sealingly contain a damping fluid, such as a silicone-based damping fluid. Isolator 10 may be initially produced and distributed without damping fluid, which may later be introduced into hydraulic chambers 34 prior to usage of isolator 10; e.g., as indicated in FIG. 1, the damping fluid may be directed into hydraulic chambers 34 through a fill port 40, which is fluidly coupled to chambers 34 via a flow passage 42 provided in rod 38. As damper piston 32 strokes during operation of isolator 10, bellows 30 expand and contract, the respective volumes of hydraulic chambers 34 increase and decrease, and damping fluid is forced through restricted annulus 36 to provide the desired damping effect. If desired, a spring-biased thermal compensation device 44 (commonly referred to as a “thermal compensator”) may further be fluidly coupled to chambers 34 via flow passage 42 to pressurize the damping fluid held within chambers 34 and to help compensate for thermally-induced fluctuations in damping fluid volume occurring during operation of isolator 10.

A tubular inner spring structure 28 is further housed within tubular isolator body 16 and may be substantially co-axial therewith. Inner spring structure 28 is mechanically coupled between damper assembly 26 and nested flexure device 12. For example, as shown in FIG. 1, a first end of inner spring structure 28 may be attached to nested flexure device 12 by a first set of bolts 46, while the opposing end of structure 28 may be attached to an outer circumferential portion of damper piston 32 by a second set of bolts 48. To help impart isolator 10 with an axially-compact form factor, nested flexure device 12 extends into a first end portion of inner spring structure 28, while one of bellows 30 and part of damper piston 32 extends into the opposing end portion of spring structure 28. An inner machined spring 50 is cut into or otherwise formed within inner spring structure 28 and serves as the secondary or tuning spring of isolator 10, as described more fully below.

With continued reference to the exemplary embodiment shown in FIG. 1, two parallel load paths are provided through isolator 10: (i) a first load path, which extends from nested flexure device 12, through isolator body 16 (and therefore through outer machined spring 24), and to axially-projecting end piece 20; and (ii) a second load path, which extends from nested flexure device 12, through inner spring structure 28 (and therefore through inner machined spring 50), through damper assembly 26, through thermal compensator 44, and to end piece 20. Isolator 10 thus comprises a three parameter device including a main spring (outer machined spring 24), which is coupled in parallel with a series-coupled secondary spring (inner machined spring 50) and a damper (damper assembly 26). As compared to other types of passive isolators, such as two parameter viscoelastic isolators, three parameter isolators provide superior attenuation of high frequency, low amplitude vibratory forces, such as jitter. Further discussion of three parameter isolators can be found in U.S. Pat. No. 5,332,070, entitled “THREE PARAMETER VISCOUS DAMPER AND ISOLATOR,” issued Jan. 26, 1984; and U.S. Pat. No. 7,182,188 B2, entitled “ISOLATOR USING EXTERNALLY PRESSURIZED SEALING BELLOWS,” issued Feb. 27, 2007; both of which are assigned to assignee of the instant application.

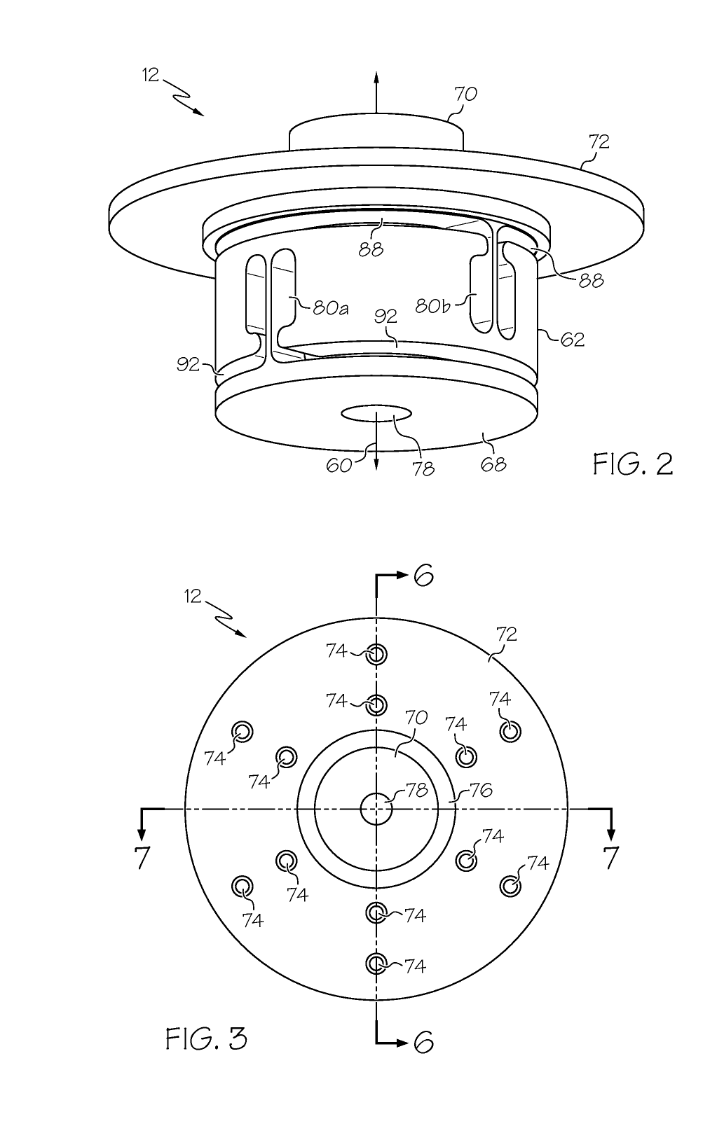

In certain instances, packaging constraints may require nested flexure device 12 to have an axially-compact form factor and, specifically, a relatively low length-to-diameter ratio; e.g., a length-to-diameter ratio less than 1:1. At the same time, it may be desirable for flexure device 12 to provide a relatively large angular ROM, such as angular ROM approach or exceeding 8°, while minimizing stress concentrations within device 12. Most, if not all, conventional flexure devices are incapable of providing such a large angular ROM in such an axially-compact envelope due to undesirably high stress concentrations occurring within the flexure device, which can prematurely limit the operational lifespan of the device. In contrast, nested flexure device 12 is able to satisfy both of these competing criteria. As a further advantage, nested flexure device 12 also helps minimize the overall axial length of isolator 10 due to the manner in which device 12 is recessed within tubular isolator body 16 and secondary spring structure 28. The manner in which nested flexure device 12 is able to provide such an axially-compact form factor and a relatively broad angular ROM will now be discussed in conjunction with FIGS. 2-9.

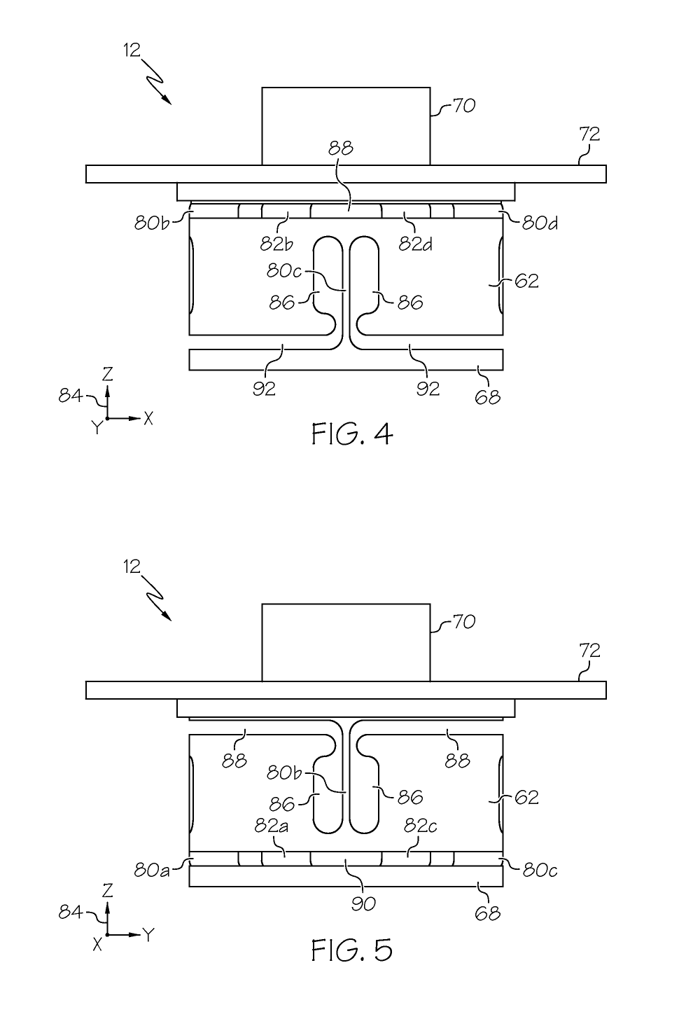

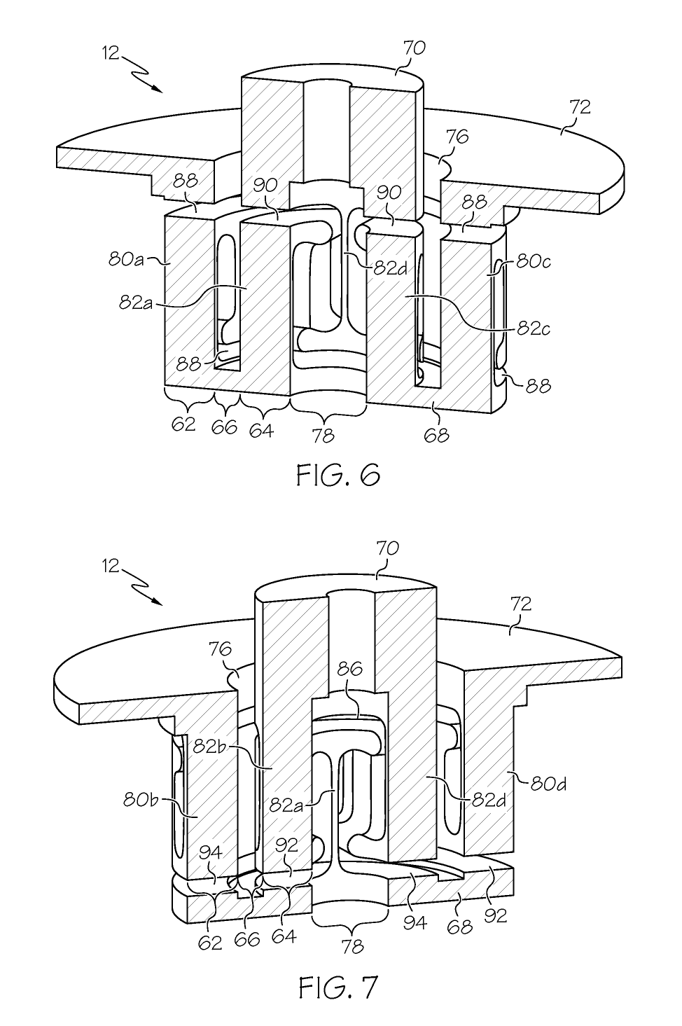

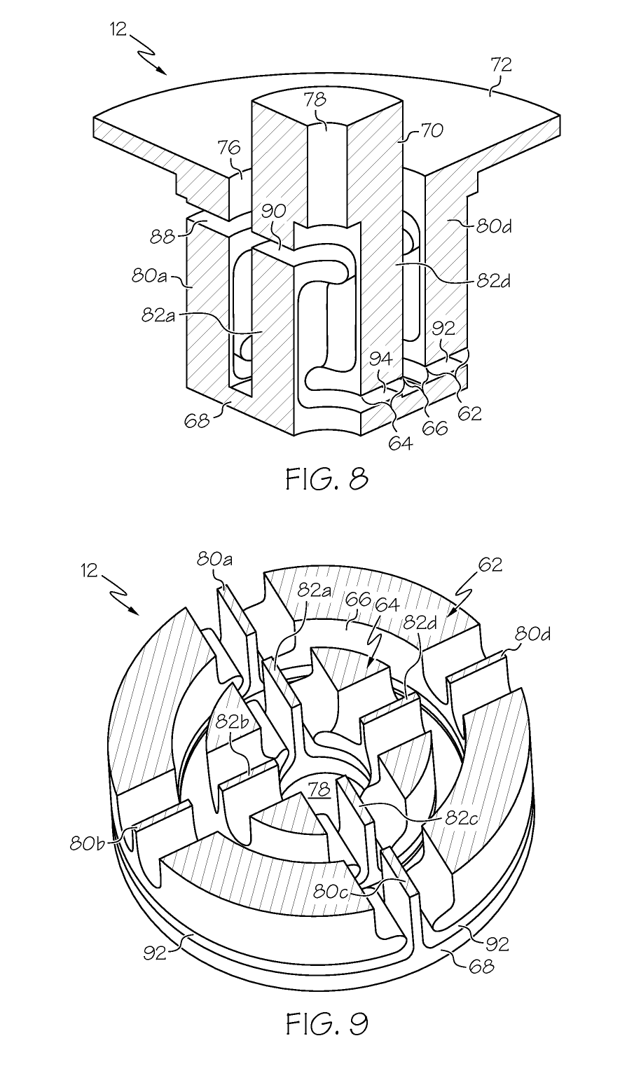

FIGS. 2, 3, and 4 are isometric, top-down, and side views of nested flexure device 12, respectively, illustrating device 12 in greater detail. FIG. 5 also provides a side view of nested flexure device 12, but rotated by 90° about the longitudinal axis of device 12 (represented by line 60 in FIG. 2) relative to the side view shown in FIG. 4. FIGS. 6 and 7 illustrated nested flexure device 12 in cross-section, as taken along lines 6-6 and 7-7, respectively, identified in FIG. 3. FIG. 8 likewise illustrates a cross-sectional view of nested flexure device 12, as taken along bent line 6-7 in FIG. 3 such that only one quarter of device 12 is shown. Finally, FIG. 9 provides a still further cross-sectional view of nested flexure device 12, as taken along a plane orthogonal to longitudinal axis 60 (FIG. 2) and extending through the below-described blades flexures of device 12. The following description refers to FIGS. 2-9 collectively in discussing the illustrated embodiment of nested flexure device 12 due to the relatively complexity of the internal structure of device 12. For ease of description, terms such as “upper,” “lower,” and the like may be utilized in reference to the illustrated orientation of nested flexure device 12 shown in FIGS. 2-9; it will be appreciated, however, that the depicted orientation of device 12 is arbitrary and that device 12 can function in any orientation in three dimensional space.

Nested flexure device 12 includes an outer annular structure or sidewall 62 (FIGS. 2 and 4-9) and an inner annular structure or sidewall 64 (FIGS. 6-9). As shown most clearly in FIGS. 6-9, outer annular sidewall 62 circumscribes or extends around at least a portion of and preferably the substantial entirety of inner annular sidewall 64. Annular sidewalls 62 and 64 further extend around longitudinal axis 60 of nested flexure device 12 (FIG. 2) such that sidewalls 62 and 64 are substantially concentric. Annular sidewalls 62 and 64 are joined at their lower ends by a disc-shaped endwall or base plate 68 (FIGS. 2 and 4-9). Annular sidewalls 62 and 64 are further radially spaced apart by a circumferential clearance or annular gap 66 (FIGS. 6-9). As indicated in FIGS. 6-9, annular gap 66 (referred to more simply below as “annulus 66”) may be concentric with the longitudinal axis 60 of nested flexure device 12 (FIG. 2), penetrate the upper end of device 12, and terminate at base plate 68. Base plate 68 thus spans or extends across annulus 66 to physically join annular sidewalls 62 and 64. Annulus 66 may be considered a blind annular or tubular bore, which is axially bound at one end by the inner radial face of base plate 68 and circumferentially bound by the inner circumferential surface of outer annular sidewall 62 and the outer circumferential surface of inner annular sidewall 64. As will be described more fully below, annulus 66 provides sufficient circumferential clearance to allow outer inner annular sidewall 64 to tilt with respect with outer annular sidewall 62 without physical contact occurring therebetween.

A radial flange 72 (FIGS. 2-8) projects from the upper edge of outer annular sidewall 62. Radial flange 72 includes a central opening 76, which may be an extension of annulus 66. An axial extension 70 (FIGS. 2-8) is joined to inner annular sidewall 64 and extends axially therefrom through opening 76 in a direction away from radial flange 72, inner annular sidewall 64, base plate 68, and the other components of flexure device 12. Radial flange 72 and axial extension 70 serve as the attachment points of nested flexure device 12. When nested flexure device 12 is installed within isolator 10 shown in FIG. 1, radial flange 72 may be bolted or otherwise attached to tubular isolator body 16 and the secondary spring structure 28 housed therein in the previously-described manner. In this regard, radial flange 72 may be fabricated to include a number of fastener openings 74 (shown in FIG. 3 only) to facilitate attachment of nested flexure device 12 to isolator body 16 and inner spring structure 28. A longitudinal channel 78 (FIGS. 2, 3 and 6-9) is further provided through nested flexure device 12 and defines the inner circumferential surface of inner annular sidewall 64. In the illustrated example, channel 78 extends through base plate 68 and through axial extension 70; and is co-axial with longitudinal axis 60 of nested flexure device 12 (FIG. 2), inner annular sidewall 64, outer annular sidewall 62, and annulus 66.

Nested flexure device 12 further includes an outer flexure system or array 80 (FIGS. 2 and 4-9) and an inner flexure system or array 82 (FIGS. 4-9). Outer flexure array 80 circumscribes or extends around at least a portion of inner flexure array 82. Inner flexure array 82 may thus be described as surrounded by, encircled by, or nested within outer flexure array 80. Outer flexure array 80 and inner flexure array 82 are coupled in series, as taken along one or more load paths through nested flexure device 12 extending between the attachment points of device 12; i.e., radial flange 72 and axial extension 76. Additionally, outer flexure array 80 and inner flexure array 82 are each compliant along at least one axis perpendicular to longitudinal axis 60 of nested flexure device 12 (FIG. 2) and, therefore, perpendicular to working axis 14 of isolator 10 (FIG. 1). As appearing herein, reference to a flexure or flexure array as “compliant” along a first axis denotes that the flexure or flexure array has a stiffness along the first axis that is less than the stiffness of the flexure or flexure array along a second axis perpendicular to the first axis. In preferred embodiments, outer flexure array 80 and inner flexure array 82 are each radially compliant; that is, compliant along first and second perpendicular axes orthogonal to longitudinal axis 60 of nested flexure device 12 and working axis 14 of isolator 10 (identified as axes “X” and “Y” by coordinate legend 84 in FIGS. 4 and 5). At the same time, it is preferred that flexure arrays 80 and 82 are each relatively stiff or rigid in an axial direction; that is, as taken along longitudinal axis 60 of device 12 and working axis 14 of isolator 10 (identified as axis “Z” by the coordinate legend 84).

Outer flexure array 80 includes a number of flexures 80(a)-(d) formed in outer annular sidewall 62 and circumferentially spaced about longitudinal axis 60 of nested flexure device 12 (FIG. 2). Similarly, inner flexure array 82 includes a number of flexures 82(a)-(d) formed in inner annular sidewall 64 and circumferentially-spaced about longitudinal axis 60. As identified in FIGS. 4 and 5, flexures 80(a)-(d) and flexures 82(a)-(d) are defined by openings 86 cut into or otherwise formed through sidewalls 62 and 64, respectively. A number of curved slots or arcuate grooves 88, 90, 92, and 94 are also cut into or otherwise formed in outer sidewall 62 and inner sidewall 64 to further define flexures 80(a)-(d) and flexures 82(a)-(d). For example, and as shown most clearly in FIGS. 6 and 8, arcuate grooves 88 and 90 may be cut into upper portions of outer annular sidewall 62 and inner annular sidewall 64, respectively. Specifically, a pair of grooves 88 may be cut into an upper portion of outer annular sidewall 62 proximate the underside of flange 72; while a pair of grooves 90 may be cut into an upper portion of inner annular sidewall 64 proximate the inner end of axial extension 70. Furthermore, grooves 88 and 90 may be radially aligned and produced utilizing a common cutting operation, such as the EDM wire process described below. Additionally, as shown most clearly in FIGS. 7 and 8, two pairs of arcuate grooves 92 and 94 may be cut into lower portions of outer sidewall 62 and inner sidewall 64, respectively. Lower arcuate grooves 92 and 94 may be located immediately above base plate 68 and may also align, as taken along different radii of nested flexure device 12.

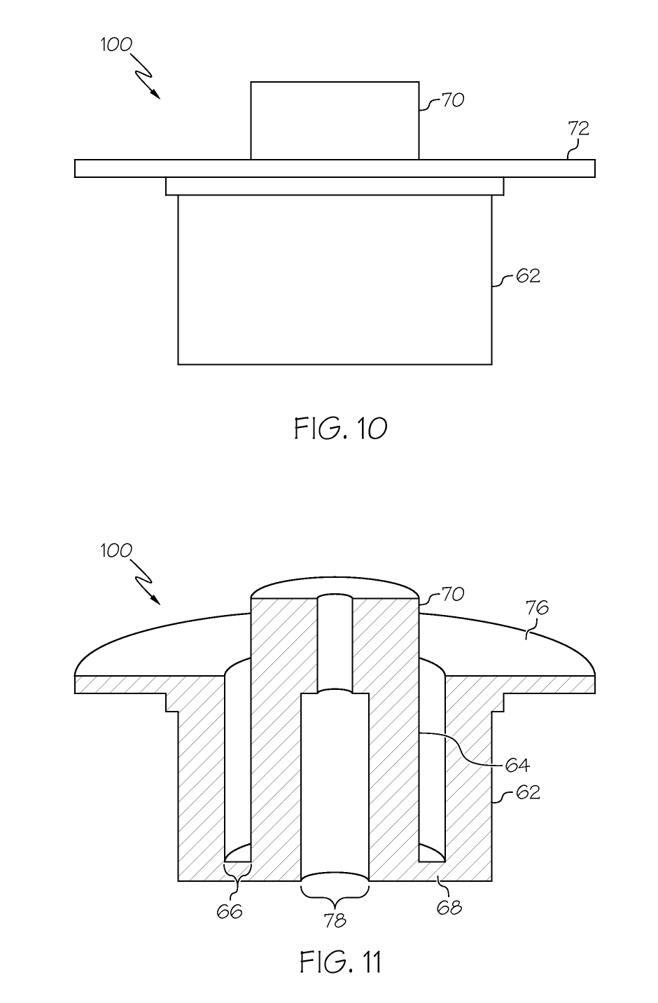

With continued reference to the exemplary embodiment shown in FIGS. 2-9, outer flexure array 80 includes a total of four flexures 80(a)-(d), which may be evenly spaced about longitudinal axis 60 of nested flexure device 12 at 90° intervals. Inner flexure array 82 likewise includes a total of four flexures 82(a)-(d), which are also evenly spaced about axis 60 at 90° intervals. In alternative embodiments, outer flexure array 80 and/or inner flexure array 82 may include fewer or a greater number of flexures, which may or may not be spaced about axis 60 at regular intervals. Furthermore, flexure arrays 80 and 82 need not include the same number or type of flexures in all embodiments. As shown most clearly in FIGS. 4-9, each flexure 80(a)-(d) included within outer flexure array 80 aligns radially (that is, aligns as taken along a radius of nested flexure device 12) with one of flexures 82(a)-(d) included within inner flexure array 82. In particular, outer flexure 80(a) aligns radially with inner flexure 82(a), outer flexure 80(b) aligns radially with inner flexure 82(b), and so on. Such radial alignment between the flexures of arrays 80 and 82 allows simultaneous formation of the flexures utilizing a common cutting operation, such as an EDM wire process of the type described in conjunction with FIGS. 10 and 11. This notwithstanding, the flexures of array 80 need not align radially with the flexures of array 82 in all embodiments; e.g., in embodiments wherein arrays 80 and 82 are formed in different pieces, which are subsequently assembled to produce nested flexure device 12, outer flexure array 80 may be clocked with respect to inner flexure array 82 by, for example, a 45° angle as taken about longitudinal axis 60 of device 12 (FIG. 2).

In the illustrated example, flexures 80(a)-(d) of array 80 and flexures 82(a)-(d) of array 82 are blade flexures, which have a rectangular cross-sectional geometry (shown most clearly in FIG. 9). Such blade flexures have a high column stiffness (that is, have a high stiff in an axial direction) and are consequently well-suited for transmitting axial forces through device 12. Additionally, the blade flexures have a relatively high cross-sectional stiffness as taken along a first axis (that is, as taken through their major cross-sectional dimension or width); while having a relatively low cross-sectional stiffness or high compliancy as taken along a second axis perpendicular to the first axis, as taken through their minor cross-sectional dimension (that is, as taken through their thickness). Due to their relative positioning around longitudinal axis 60 (FIG. 2) and their respective orientations, certain flexures in arrays 80 and 82 are compliant along a first axis perpendicular to longitudinal axis 60 (FIG. 2) and working axis 14 of isolator 10 (FIG. 1), while other flexures in arrays 80 and 82 are compliant along a second axis perpendicular to longitudinal axis 60 and working axis 14. In particular, a first subset of the flexures included within array 80 (flexures 80(a) and 80(c)) and a first subset of flexures included within array 82 (flexures 82(a) and 82(c)) are compliant along a first axis orthogonal to longitudinal axis 60 and working axis 14, namely, the X-axis identified in FIGS. 4 and 5 by coordinate legend 84. Similarly, a second subset of the flexures included within array 80 (flexures 80(b) and 80(d)) and a second subset of flexures included within array 82 (flexures 82(b) and 82(d)) are compliant along a second axis orthogonal to longitudinal axis 60 and working axis 14, namely, the Y-axis identified by coordinate legend 84.

Flexure arrays 80 and 82 each contain flexures that are compliant along the same axis and coupled in series, as taken along a load path through nested flexure device 12. For example, flexure 80(a) of outer flexure array 80 and flexure 82(a) of inner flexure array 82 are coupled in series and have their greatest compliancy along the X-axis identified in FIGS. 4 and 5. Flexure 80(c) of array 80 and flexure 82(c) of array 82 are likewise coupled in series and have their greatest compliancy along the X-axis identified in FIGS. 4 and 5. Similarly, flexure 80(b) of array 80 and flexure 82(b) of array 82 are coupled in series and have their greatest compliancy along the Y-axis identified in FIGS. 4 and 5. Finally, flexure 80(d) of array 80 and flexure 82(d) of array 82 are further coupled in series and have their greatest compliancy along the Y-axis in FIGS. 4 and 5. Stated differently, outer flexure array 80 has a first subset of blade flexures (flexures 80(a) and 80(c)) oriented to have a higher compliancy along a first axis perpendicular to working axis 60 (e.g., the X-axis in FIGS. 4 and 5) than along a second axis perpendicular to the first axis (e.g., the Y-axis in FIGS. 4 and 5), and a second subset of blade flexures (flexures 80(b) and 80(d)) oriented to have a higher compliancy along the second axis than along the first axis. Inner flexure array 82 likewise includes a first subset of blade flexures (flexures 82(a) and 82(c)) oriented to have a higher compliancy along the first axis than along the second axis, and a second subset of blade flexures (flexures 82(b) and 82(d)) oriented to have a higher compliancy along a second axis than along the first axis. Furthermore, the first subset of blade flexures included within inner flexure array 82 is coupled in series with the first subset of blade flexures included within outer flexure array 80, and wherein the second subset of blade flexures included within inner flexure array 82 is coupled in series with the second subset of blade flexures included within outer flexure array 80.

As a result of the above-described structural configuration, rotational misalignments about perpendicular axes orthogonal to longitudinal axis 60 (i.e., the X- and Y-axes in FIGS. 4 and 5) are shared substantially equally between the flexures of outer flexure array 80 and the flexures of inner flexures array 82. The series-coupled flexures of arrays 80 and 82 thus effectively act as single array of flexures having a length twice that of any given flexure within arrays 80 and 82 thereby reducing stress concentrations within the compliant regions of flexure device 12. This, in turn, allows the angular ROM of nested flexure device 12 to be maximized and, possibly, to approach or exceed 8° in at least some cases. Furthermore, the overall axial length of device 12 can be minimized due to the manner in which inner flexure array 82 is nested within outer flexure array 80; e.g., in one embodiment, the axial length of device 12 is less than the diameter thereof. It will also be noted that, due to the nested design of device 12, any given load path through device 12 will have a substantially sinusoidal or undulating portion or segment extending through outer flexure array 80, base plate 68, and inner flexure array 82. Bending of the flexures included within arrays 80 and 82 thus allows relative rotational displacement or tilting between end piece 70, inner annular sidewall 64, base plate 68, outer annular sidewall 62, and radial flange 72 during rotational or angular deflection of nested flexure device 12 to impart device 12 with a relatively broad angular ROM.

Nested flexure device 12 can be produced from multiple discrete components, which are assembled to produce device 12; e.g., inner annular sidewall 64, inner flexure array 82, and axial extension 70 may be produced as a first machined piece, which seats within and is affixed (e.g., welded) to a second machined piece including outer annular sidewall 62, outer flexure array 80, radial flange 72, and base plate 68. However, in preferred embodiments, nested flexure device 12 is produced as a monolithic structure or single piece. In this case, fabrication of nested flexure device 12 may commence with the provision of a monolithic body of resilient material, such as a length of bar stock. The resilient body of material may then be machined to a near net shape utilizing, for example, a lathing process. FIG. 11 illustrates such a monolithic body of resilient material 100 (referred to hereafter as “resilient body 100”) after external machining to generally define the outer circumferential surface of outer annular sidewall 62, radial flange 72, and axial extension 70. In one embodiment, resilient body 100 is composed of a resilient metal or alloy, such as a titanium alloy.

Next, additional material removal processes may be carried-out to produce longitudinal channel 78 through resilient body 100 and annulus 66, as generally shown in FIG. 12. For example, one or more drilling or lathing processes may be utilized to produce channel 78 and thereby define the inner circumferential wall of inner annular sidewall 60; while an EDM plunging process is utilized to create annulus 66 and thereby define the inner circumferential wall of outer annular sidewall 62, the outer circumferential wall of inner annular sidewall 64, and the inner radial face of base plate 68. The EDM plunging process may be performed utilizing a tubular or cup-shaped electrode having a wall thickness corresponding to the desired radial width of annulus 66. Afterwards, an additional cutting process, such as an EDM wire process, may be performed to remove selected regions of resilient body 100 and thereby create outer flexure array 80, inner flexure array 82, and arcuate grooves 88, 90, 92, and 94. Notably, during the EDM wire process, the radially aligning flexures of arrays 80 and 82 may be formed simultaneously utilizing an electrode having a sufficient length to penetrate both outer annular sidewall and inner annular sidewall 64. Radially-aligning grooves 88 and 90 and radially-aligning grooves 92 and 94 may likewise be formed simultaneously utilizing the same or similar EMD wire process.

There has thus been provided embodiments of a nested flexure device having an axially-compact form factor and a relatively large angular ROM. In preferred embodiments, the nested flexure device comprises a monolithic resilient structure in which the inner and outer flexure arrays are formed. Embodiments of single DOF isolator including such an axially-compact flexure device have also been provided. While described above primarily in conjunction with a single DOF, axially-damping isolator, it is emphasized that embodiment of the nested flexure device can be utilized within any application wherein it is desired to provide angular compliancy between mount points, while transmitting axial forces therebetween. In this regard, embodiments of the above-described nested flexure device are well-suited for usage in place of ball joints in instances wherein it is desired to eliminate joints to, for example, reduce stiction and/or to provide superior transmission of low amplitude vibratory forces along the longitudinal axis of the flexure. Finally, the foregoing has also provided embodiments of a method for producing an axially-compact, radially-compliant nested flexure device.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. An isolator having a working axis, comprising:
an isolator body; and
a nested flexure device mounted to an end portion of the isolator body, the nested flexure device comprising:
an inner flexure array compliant along first and second perpendicular axes orthogonal to the working axis; and
an outer flexure array compliant along the first and second perpendicular axes, coupled in series with the inner flexure array, and circumscribing at least a portion of the inner flexure array.

2. The isolator of claim 1 wherein the inner flexure array and the outer flexure array each comprise a plurality of blade flexures circumferentially spaced about the working axis of the isolator.

3. The isolator of claim 2 wherein each blade flexure included within the inner flexure array is radially aligned with one of the blade flexures included within the outer flexure array.

4. The isolator of claim 1 wherein any given load path taken through the nested flexure device has a substantially sinusoidal portion extending through inner flexure array and outer flexure array.

5. The isolator of claim 1 wherein the inner flexure array and the outer flexure array each comprise:
a first subset of blade flexures oriented to have a higher compliancy along the first axis than along the second axis; and
a second subset of blade flexures oriented to have a higher compliancy along the second axis than along the first axis.

6. The isolator of claim 5 wherein the first subset of blade flexures included within the inner flexure array is coupled in series with the first subset of blade flexures included within the outer flexure array, and wherein the second subset of blade flexures included within the inner flexure array is coupled in series with the second subset of blade flexures included within the outer flexure array.

7. The isolator of claim 1 wherein the nested flexure device further comprises an outer annular sidewall in which the outer flexure array is formed.

8. The isolator of claim 7 wherein the nested flexure device further comprises an inner annular sidewall in which the inner flexure array is formed, the inner annular sidewall extending around the outer annular sidewall.

9. The isolator of claim 8 wherein the inner annular sidewall and the outer annular sidewall are substantially concentric.

10. The isolator of claim 8 wherein the inner annular sidewall and the outer annular sidewall are separated by an annular gap.

11. The isolator of claim 10 wherein the nested flexure device further comprises an end plate extending across the annular gap to join the inner and outer annular sidewalls.

12. The isolator of claim 11 further comprising an axial extension joined to the inner annular sidewall and extending away therefrom in a direction opposite the end plate.

13. The isolator of claim 7 further comprising a radial flange extending from the outer annular sidewall and affixed to the isolator body.

14. The isolator of claim 1 wherein the nested flexure device comprises a monolithic resilient structure in which the inner flexure array and the outer flexure array are formed.

15. The isolator of claim 1 wherein the isolator body comprises a tubular end portion in which the nested flexure device is recessed.

16. A nested flexure device having a longitudinal axis, comprising:
an inner flexure array compliant along first and second perpendicular axes orthogonal to the longitudinal axis; and
an outer flexure array compliant along the first and second perpendicular axes, coupled in series with the inner flexure array, and circumscribing at least a portion of the inner flexure array.

17. The nested flexure device of claim 16 further comprising a monolithic resilient structure having an inner annular sidewall and an outer annular sidewall, wherein in the inner flexure array comprises a plurality of blade flexures formed in the inner annular sidewall, and wherein the outer flexure array comprises a plurality of flexures formed in the outer annular sidewall.

18. A method for producing a nested flexure device, comprising:
providing a monolithic body of resilient material having a longitudinal axis, an inner annular sidewall extending around the longitudinal axis, and an outer annular sidewall circumscribing at least a portion of the inner annular sidewall;
forming an inner flexure array in the inner annular sidewall and compliant along first and second perpendicular axes orthogonal to the longitudinal axis; and
forming an outer flexure array in the outer annular sidewall, compliant along the first and second perpendicular axes, and coupled in series with the inner flexure array.

19. The method of claim 18 wherein providing comprises cutting an annular gap into a monolithic body of resilient material defining, in part, the inner annular sidewall and the outer annular sidewall.

20. The method of claim 18 wherein the inner flexure array is formed to include a first blade flexure, wherein outer flexure array is formed to include a second blade flexure, and wherein the first and second blade flexures are formed by simultaneously removing material from the inner annular sidewall and the outer annular sidewall.
